(19) United States
(12) Patent Application Publication
(10) Pub. No.: US 2023/0227379 A1
(43) Pub. Date: Jul. 20, 2023

(54) STABILIZED UREA CALCIUM SULPHATE ADDUCT COATED WITH A BASE AN UREASE INHIBITOR

(71) Applicant: SABIC Global Technologies B.V., Bergen op Zoom (NL)

(72) Inventors: Rajamalleswaramma KORIPELLY, Bangalore (IN); Andrew George KELLS, Wilton (GB); Nilkamal BAG, Bangalore (IN); Samik GUPTA, Bangalore (IN)

(73) Assignee: SABIC Global Technologies B.V., Bergen op Zoom (NL)

(21) Appl. No.: 18/002,432

(22) PCT Filed: Jun. 29, 2021
(86) PCT No.: PCT/IB2021/055807

§ 371 Date: Dec. 19, 2022

(30) Foreign Application Priority Data
Jul. 1, 2020 (IN) 202011027979

(51) Int. Cl. C05G 3/90; C05G 1/00; C05G 5/30; C05B 17/00; C05C 9/00; C05D 3/00

(52) U.S. Cl. CPC C05G 3/90; C05G 1/00; C05G 5/30; C05B 17/00; C05C 9/00; C05D 3/00

(57) ABSTRACT

A fertilizer granule containing a core containing, phosphoric acid and an urea adduct containing urea and calcium sulfate, and a coat containing an urease inhibitor and a base, the coat forming a coating on an outer surface of the core. Methods of making and using the fertilizer granule are also disclosed.

### CROSS REFERENCE TO RELATED APPLICATIONS

This application claims priority to and the benefit of priority of Indian Provisional Application No. 202011027979, filed Jul. 1, 2020, which is hereby incorporated by reference in its entirety.

### BACKGROUND OF THE INVENTION

### A. Field of the Invention

The invention generally concerns a particulate fertilizer composition containing coated urea calcium sulfate (UCS) adduct. In particular, the invention concerns fertilizer granules containing: a core containing phosphoric acid and an urea adduct containing urea and calcium sulfate; and a coat containing a urease inhibitor and a base, the coat forming a coating on an outer surface of the core.

### B. Description of Related Art

Soil nutrients, such as nitrogen, phosphorus, potassium, and sulfur, as well as trace elements such as iron, zinc, copper, and magnesium, are useful for achieving thriving agriculture and growth of plants. Upon repeated planting cycles, the quantity of these nutrients in the soil may be depleted, resulting in inhibited plant growth and decreased production. To counter this effect, fertilizers have been developed to help replace the depleted vital nutrients. Single-nutrient fertilizers and multi-nutrient fertilizers, such as fertilizer blends, have been developed to meet the varied needs of crop production worldwide.

Fertilizers containing nitrogen are used to support healthy plant growth and photosynthesis. Urea (CH₄N₂O) is a compound that contains nitrogen and is widely used as a nitrogen source in fertilizers. However, due to its rapid hydrolysis and nitrification in the soil, nitrogen from urea can be quickly lost. Also, using urea in fertilizer blends that contain other soil nutrients is difficult, as urea can undesirably react with other components in the fertilizer, such as organic fertilizers. These reactions can produce water that liquefies solid granules or dry mixture products, cause clumping and loss of product, and increase the rate at which these undesirable reactions take place. See Biskupski et al. (EP 2,774,907); see also Achard et al. (U.S. Pat. No. 5,409,516). Further, the production of water increases the amount of water that has to be removed during production of urea containing fertilizers, making these blended fertilizers difficult and more expensive to make. See Schwob (FR 2,684,372).

Some of the problems with using urea in fertilizers have been reduced by binding urea to calcium sulfate as a calcium sulfate urea adduct (UCS) or reacting urea with rock phosphate and sulfuric acid to form urea associated with superphosphate (monocalcium phosphate; Ca(H₂PO₄)₂) and/or dicalcium phosphate (CaHPO₄) (see WO 01/42172, WO 19/016761, CN108530175, CN103086781, CN103086810, EP2774907, U.S. Pat. Nos. 2,074,880, 4,283,423, 5,409,516, GB1189398, Achard et al. Phosphorus and potassium 191 (1994): 27-33, Whittaker et al. Ind. Eng. Chem. 1933, 25, 11, 1280-1282, Malinowski et al. Polish Journal of Chemical Technology 9, no. 4 (2007): 111-114). Calcium sulfate for the UCS adduct can be obtained from phosphogypsum (see Firsova, Vestnik Moskovskogo Universiteta. Khimiya, 2010, No. 4, pp. 331-336). Phosphogypsum can be produced during the phosphoric acid manufacturing process and is generally disposed of. However, there are difficulties in using phosphogypsum to produce UCS. Some difficulties include that the stability of urease inhibitors can be decreased in the presence of a UCS adduct obtained from phosphogypsum, reducing the ability of urease inhibitors to reduce hydrolysis of urea in the fertilizer.

### SUMMARY OF THE INVENTION

A solution to at least some of the problems discussed above has been discovered. Phosphogypsum can contain phosphoric acid and an UCS adduct containing product obtained from the phosphogypsum can retain at least a portion of the phosphoric acid. Without wishing to be bound by theory it is believed that phosphoric acid can degrade urease inhibitors. In some aspects, the solution resides in coating a core containing UCS and phosphoric acid, with a coat containing a urease inhibitor and base. The base can reduce hydrolysis of urease inhibitor and can also be configured to provide a secondary nutrient such Ca and/or Mg. Further, the coated fertilizer can contain high concentrations of nitrogen (e.g., up to 46 wt. %) and/or a secondary nutrient such Ca and/or Mg (e.g., up to 5 wt. %), or a combination thereof. These nutrients can be provided in a single application by using the coated fertilizers described herein.

One aspect of the present invention is directed to a fertilizer granule. The fertilizer granule can contain a core and a coat, the coat forming a coating on an outer surface of the core. The core can contain a urea adduct and phosphoric acid. The urea adduct can be a urea-calcium sulfate (UCS) adduct and can contain urea and calcium sulfate. The UCS adduct can be CaSO₄.4CO(NH₂)₂. In certain aspects, the core can further contain free urea that is not contained in the UCS adduct and/or free calcium sulfate that is not contained in the UCS adduct. In some aspects, the core can contain i) 47 wt. % to 79.5 wt. %, preferably 60 wt. % to 72 wt. % of urea in total, present freely and/or within the UCS adduct, ii) 20 wt. % to 45 wt. %, preferably 28 wt. % to 40 wt. % of CaSO₄ in total, present freely and/or within the UCS adduct and iii) 0.1 wt. % to 3 wt. %, preferably 0.2 wt. % to 1.2 wt. % of phosphoric acid, based on the total weight of the core. In some aspects, the core can contain 40 wt. % to 85 wt. % of UCS adduct.

The components of the core, such as the UCS adduct, phosphoric acid, the free urea, and the free calcium sulfate can be distributed homogeneously or heterogeneously within the core. The calcium sulfate present freely and contained within the UCS adduct in the core can be obtained from phosphogypsum. In some aspects, the phosphogypsum can be obtained from a phosphoric acid manufacturing process. The UCS adduct in the core can be formed from an adduct forming reaction between calcium sulfate from phosphogypsum and urea. In some aspects, 90 wt. % to 99 wt. % of the fertilizer granule can be comprised of the core.

The coat can contain a urease inhibitor and a base. The base can contain an oxide, carbonate, acetate, and/or hydroxide of a group 1 metal, group 2 metal, group 13 metal, and/or ammonium. In certain aspects, the base can contain CaO and/or MgO. In certain particular aspects, the base can be MgO. In certain aspects, the base such as MgO can be comprised in particulate solids. In certain aspects, the particulate solids can have an average diameter of 0.1 μm to 150 μm or 1 μm to 50 μm. In certain aspects, the urease inhibitor can contain a thiophosphoric triamide derivative or phenyl phosphorodiamidate (PPDA). In certain aspects, the thiophosphoric triamide derivative can be N-(n-butyl) thiophosphoric triamide (NBPT). In some aspects, the fertilizer granule can comprise 0.2 wt. % to 7 wt. % of the base, such as MgO. In some aspects, the fertilizer granule can comprise 0.01 wt. % to 0.2 wt. % of the urease inhibitor, such as NBPT. In some aspects, the fertilizer granule can contain NBPT and MgO at a weight ratio of 0.005:1 to 0.1:1. In some aspects, the fertilizer granule can contain 0.2 wt. % to 8 wt. % of the coat, e.g., 0.2 wt. % to 8 wt. % of the fertilizer granule can be comprised of the coat. In some aspects, the weight ratio of the coat to the core in the fertilizer granule can be about 0.01:1 to 0.07:1.

The coat can contain one or more layers and can form one or more coating layers over the core. In certain aspects, the base and the urease inhibitor can be contained in the same coating layer. In certain aspects, the base and the urease inhibitor can be contained in different layers. In certain aspects, the coat can contain one or more layers each independently containing the base and/or the urease inhibitor. In some particular aspects, the coat can contain at least two coating layers, a base containing alkaline coating layer and an urease inhibitor containing inhibitor coating layer. In some aspects, at least a portion of the alkaline coating layer can be arranged between the core and the inhibitor coating layer. The alkaline coating layer can form a coating over the core to form a base coated core and the inhibitor coating layer can form a coating over the base coated core to form the fertilizer particle. The inhibitor coating layer can form an outer layer of the fertilizer particle. In some other aspects, at least a portion of the inhibitor coating layer can be arranged between the core and the alkaline coating layer. The inhibitor coating layer can form a coating over the core to form an inhibitor coated core and the alkaline coating layer can form a coating over the inhibitor coated core to form the fertilizer particle. The alkaline coating layer can form an outer layer of the fertilizer particle.

In certain aspects, the core can further contain an additional nitrogen nutrient. The additional nitrogen nutrient is a nutrient other than urea, and can deliver nitrogen to a plant. In some aspects, the additional nitrogen nutrient can include ammonium nitrate, ammonium sulfate, diammonium phosphate, monoammonium phosphate, urea-formaldehyde, ammonium chloride, and potassium nitrate.

In certain aspects, the coat can further contain a nitrification inhibitor. In some particular aspects, the urease inhibitor containing inhibitor coating layer can further contain a nitrification inhibitor. In some aspects, the nitrification inhibitor can be 3,4-dimethylpyrazole phosphate (DMPP), thio-urea (TU), dicyandiamide (DCD), 2-Chloro-6-(trichloromethyl)-pyridine (Nitrapyrin), 5-Ethoxy-3-trichloromethyl-1, 2, 4-thiadiazol (Terrazole), 2-Amino-4-chloro-6-methyl-pyrimidine (AM), 2-Mercapto-benzothiazole (MBT), or 2-Sulfanimalamidothiazole (ST) or any combination thereof, preferably DCD. In some aspects, the fertilizer particle can include 0.1 wt. % to 5 wt. % of the nitrification inhibitor such as DCD. In certain aspects, the coat can further contain a micronutrient. In certain aspects, the base containing alkaline coating layer can further contain a micronutrient. A micronutrient is a botanically acceptable form of an inorganic or organometallic compound, such as boron, copper, iron, chloride, manganese, molybdenum, nickel, or zinc. In certain aspects, the core and/or the coat can be essentially free of or contain less than 5 wt. % or less than 3 wt. % or less than 1 wt. % of a filler and/or binder, such as each of bleached wheat flour, starch, gluten, kaolin, bentonite, dried distillers grains with solubles (DDGS), bone mill powder, or rice husk.

The core can be of any suitable shape. Non-limiting shape includes spherical, cuboidal, cylindrical, puck shape, oval, and oblong shapes, although cores having other shapes can also be made. In some aspects, the core can be spherical. In some aspects, the core can be of cylindrical shape with a circular, elliptical, ovular, triangular, square, rectangular, pentagonal, or hexagonal cross section, although cylindrical shaped core having a cross-section of other shapes can also be made. In some aspects, the core can have a dimension such as length, width, height and/or cross-sectional diameter between 0.5 mm to 5 mm. In some aspects, the core can have a substantially spherical shape with an average diameter 1 mm to 5 mm. In some aspects, the core can be a prill or can be a granulated, pelletized, compacted, and/or agglomerated core. In some aspects, the core can be a granulated core.

In some aspects, the coat can cover at least 10%, 20%, 30%, 40%, or 10% to 50% of the outer surface of the core. In other aspects, the coat can cover a majority (e.g., greater than 50%) of the outer surface of the core. In some aspects, the coat can cover greater than 50%, at least 60%, at least 70%, at least 80%, at least 90%, or 100% of the outer surface of the core. In certain aspects, the coat can cover 60% to 100% or 80% to 100% or 90% to 100% of the outer surface of the core. In some aspects, the alkaline coating layer can make up about 0.2 wt. % to 7 wt. % of the fertilizer granule. In some aspects, the inhibitor coating layer can make up about 0.01 wt. % to 0.2 wt. % of the fertilizer granule.

In some aspects, the fertilizer granule can be included in a fertilizer blend or a compounded fertilizer. The fertilizer blend or the compounded fertilizer in addition to the fertilizer granules can contain a second fertilizer granule. In some aspects, the second fertilizer granules can contain urea, monoammonium phosphate (MAP), diammonium phosphate (DAP), muriate of potash (MOP), monopotassium phosphate (MKP), triple super phosphate (TSP), rock phosphate, single super phosphate (SSP), or the like.

One aspect of the present invention is directed to a method for making a fertilizer granule, such as a fertilizer granule disclosed herein. In certain aspects, the method can include forming or providing a core containing phosphoric acid and an urea adduct containing urea and calcium sulfate; and coating an outer surface of the core with an urease inhibitor, a base, and optionally a nitrification inhibitor and/or a micronutrient to form a coat. In some aspects, the coat can be formed by contacting the outer surface of the core with the urease inhibitor and optionally the nitrification inhibitor to form an inhibitor coated core, and contacting an outer surface of the inhibitor coated core with particulate solids comprising the base and optionally a micronutrient. In some aspects, the coat can be formed by contacting the outer surface of the core with particulate solids containing the base and optionally a micronutrient to form a base coated core, and contacting an outer surface of the base coated core with an urease inhibitor and optionally a nitrification inhibitor. In some aspects, the coat can be formed by contacting the outer surface of the core with a combination of particulate solids containing the base and an urease inhibitor and optionally a micronutrient and/or a nitrification inhibitor. In certain aspects, a solution containing the urease inhibitor can be contacted with the outer surface of the core or the base coated core. In some particular aspects, the solution can be a aqueous solution containing 15 wt. % to 40 wt. % of the urease inhibitor. In some aspects, the core or based coated core can be coated with 0.3 kg to 3 kg of the urease inhibitor such as NBPT per ton of the urea, e.g., urea present freely and in the UCS adduct, in the core. In some aspects, the core or inhibitor coated core can be coated with 2 kg to 30 kg of base such as MgO per ton of urea, e.g. present freely and in the UCS adduct in the core.

The core can be formed by contacting urea with phosphogypsum. In certain aspects, the core can be formed by contacting urea with phosphogypsum to form a slurry containing a UCS adduct, drying the slurry to form a dried UCS adduct and granulating the dried UCS adduct to form the core. The urea and phosphogypsum can be contacted in presence of water to form the slurry. In certain aspects, urea in form of a urea solution, urea particles, urea granules, or urea prills or any combination thereof can be contacted with the phosphogypsum to form the slurry. In some aspects, the phosphogypsum having 3 wt. % to 30 wt. % of moisture can be contacted with urea to form the slurry. In some aspects, the slurry can contain 10 wt. % to 40 wt. % of water. Urea can be contacted with phosphogypsum at a molar ratio of 3:1 to 5:1 of urea to calcium sulfate contained in the phosphogypsum. In certain aspects, the slurry can be dried at 35° C., 40° C., 45° C., 50° C., 55° C., 60° C., 65° C., 70° C., 75° C., 80° C., 85° C., 90° C., 95° C., 100° C. or greater, or any temperature or range thereof or there between to form the dried UCS adduct. The amount of water e.g. moisture in the dried UCS adduct can be less than 0.6 wt. %, 0.5 wt. %, 0.4 wt. %, 0.3 wt. %, 0.2 wt. %, 0.1 wt. %, or less, or any amount or range thereof or there between. The dried UCS adduct can be granulated at a temperature of 65° C. to 95° C. The amount of UCS adduct in the core can be 40 wt. %, over 40 wt. %, over 45 wt. %, over 50 wt. %, over 55 wt. %, over 60 wt. %, over 65 wt. %, over 70 wt. %, over 75 wt. %, over 80 wt. %, over 85 wt. %, or any amount or range thereof or there between.

Forming the core can include adding additional urea, additional calcium sulfate, additional UCS adduct, additional water, and aqueous solution, and/or one or more additives. In some instances, the additional water can be added in the form of steam. The aqueous solution can in some instances be a scrubber solution. The scrubber solution can be acidic, contain ammonia, and/or contain a source of nitrogen, phosphorous, and/or potassium. In some instances, the scrubber solution is scrubber solution for scrubbing or that has already been used for scrubbing dryer air and/or reducing dust particles from production of a fertilizer, such as the UCS fertilizer granule, and/or a nitrogen (N), phosphorous (P), and/or potassium (K) (e.g., NP, NK, or NPK) fertilizer. The additive can be a fertilizer, a secondary nutrient, or an organic agent. The additive can be a fertilizer, compound, or composition that provides a nitrogen based fertilizer, a phosphate-based fertilizer, a potassium-based fertilizer, a urea-based fertilizer, a fertilizer providing nitrogen-phosphorus-potassium (NPK), diammonium phosphate (DAP), monoammonium phosphate (MAP), single superphosphate (SSP), triple superphosphate (TSP), urea, potassium chloride, potassium sulfate, magnesium sulfate, superphosphates, rock phosphate, potash, sulfate of potash (SOP), muriate of potash (MOP), kieserite, carnallite, magnesite, dolomite, boric acid, boron (B), copper (Cu), iron (Fe), manganese (Mn), molybdenum (Mo), zinc (Zn), selenium (Se), silicon (Si), Ca, magnesium (Mg), elemental sulfur (S), neem oil, seaweed extract, bio-stimulants, char, ashes from incineration of animal waste or animal tissues, or any combination thereof. In some aspects, the core can be formed as a prill.

One aspect of the present invention is directed to a method of fertilizing, the method comprising applying the fertilizer granule and/or a fertilizer blend containing the fertilizer granule to at least a portion of a soil, a crop, or the soil and the crop. Also disclosed is a method of enhancing plant growth comprising applying to soil, the plant, or the soil and the plant an effective amount of a composition comprising a fertilizer blend of the present invention.

In the context of the present invention, fertilizer granules and/or fertilizer blend granules may also be referred to as a particle, granule, fertilizer particle, prill, or fertilizer prill.

The term “fertilizer” is defined as a material applied to soils or to plant tissues to supply one or more plant nutrients essential or beneficial to the growth of plants and/or stimulants or enhancers to increase or enhance plant growth. Non-limiting examples of fertilizers include materials having one or more of urea, ammonium nitrate, calcium ammonium nitrate, one or more superphosphates, binary NP fertilizers, binary NK fertilizers, binary PK fertilizers, NPK fertilizers, molybdenum, zinc, copper, boron, cobalt, and/or iron. In some aspects, fertilizers include agents that enhance plant growth and/or enhance the ability for a plant to receive the benefit of a fertilizer, such as, but not limited to biostimulants, urease inhibitors, and nitrification inhibitors. In some particular instances, the fertilizer is urea, such as urea granules or prills.

The term “granule” can include a solid material. A granule can have a variety of different shapes, non-limiting examples of which include a spherical, a puck, an oval, a rod, an oblong, or a random shape.

The term “particle” can include a solid material less than a millimeter in its largest dimension.

The terms “particulate” or “powder” can include a plurality of particles.

The terms “aqueous based,” “aqueous base,” “water based,” and “water base” are defined as containing water or was previously contained in water before drying.

The terms “about” or “approximately” as used herein are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol. %,” or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The phrase “and/or” can include “and” or “or.” To illustrate, A, B, and/or C can include:

A alone, B alone, C alone, a combination of A and B, a combination of A and C, a combination of B and C, or a combination of A, B, and C.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

In the context of the present invention, at least the following 20 aspects are described.

Aspect 1 is directed to a fertilizer granule comprising:
a core comprising phosphoric acid and an urea adduct comprising urea and calcium sulfate; and
a coat comprising an urease inhibitor and a base, the coat forming a coating on an outer surface of the core.

Aspect 2 is directed to the fertilizer granule of aspect 1, wherein the base is an oxide, carbonate, bicarbonate, acetate, and/or hydroxide of a group 1 metal, group 2 metal, group 13 metal, and/or ammonium.

Aspect 3 is directed to the fertilizer granule of any one of aspects 1 or 2, wherein the base is CaO and/or MgO, preferably MgO.

Aspect 4 is directed to the fertilizer granule of any one of aspects 1 to 3, wherein the urease inhibitor is a thiophosphoric triamide derivative, preferably N-(n-butyl) thiophosphoric triamide (NBPT).

Aspect 5 is directed to the fertilizer granule of any one of aspects 1 to 4, wherein the coat comprises an alkaline coating layer comprising the base and an inhibitor coating layer comprising the urease inhibitor, wherein the alkaline coating layer and the inhibitor coating layer form separate coating layers.

Aspect 6 is directed to the fertilizer granule of aspect 5, wherein at least a portion of the alkaline coating layer is arranged between the core and the inhibitor coating layer.

Aspect 7 is directed to the fertilizer granule of aspect 5, wherein at least a portion of the inhibitor coating layer is arranged between the core and the alkaline coating layer.

Aspect 8 is directed to the fertilizer granule of any one of aspects 1 to 7, wherein the base is comprised in particulate solids.

Aspect 9 is directed to the fertilizer granule of aspect 8, wherein the particulate solids have an average diameter of 0.1 μm to 150 μm, preferably 1 μm to 50 μm.

Aspect 10 is directed to the fertilizer granule of any one of aspects 1 to 9, wherein the core comprises: 47 wt. % to 79.5 wt. %, preferably 60 wt. % to 72 wt. % of urea; 20 wt. % to 45 wt. %, preferably 28 wt. % to 40 wt. % of calcium sulfate; and 0.1 wt. % to 3 wt. %, preferably 0.2 wt. % to 1.2 wt. % of phosphoric acid, based on the total weight of the core.

Aspect 11 is directed to the fertilizer granule of any one of aspects 1 to 10, wherein 90 wt. % to 99 wt. % of the fertilizer granule is comprised of the core.

Aspect 12 is directed to the fertilizer granule of any one of aspects 1 to 11, wherein the fertilizer granule comprises 0.2 wt. % to 7 wt. % of the base.

Aspect 13 is directed to the fertilizer granule of any one of aspects 1 to 12, wherein the fertilizer granule comprises 0.01 wt. % to 0.2 wt. % of the urease inhibitor.

Aspect 14 is directed to the fertilizer granule of any one of aspects 1 to 13, wherein at least a portion of the calcium sulfate in the core is obtained from phosphogypsum.

Aspect 15 is directed to the fertilizer granule of aspect 14, wherein the phosphogypsum is obtained from a phosphoric acid manufacturing process.

Aspect 16 is directed to the fertilizer granule of any one of aspects 1 to 15, comprised in a fertilizer blend or a compounded fertilizer.

Aspect 17 is directed to a method for making the fertilizer granule of any one of aspects 1 to 16, the method comprising:
forming or providing a core comprising phosphoric acid and an urea adduct comprising urea and calcium sulfate; and
coating an outer surface of the core with a urease inhibitor and a base to form a coat.

Aspects 18 is directed to the method of aspect 17, wherein the coat is formed by contacting the outer surface of the core with a solution comprising the urease inhibitor to form an inhibitor coated core, and contacting an outer surface of the inhibitor coated core with particulate solids comprising the base.

Aspects 19 is directed to the method of aspect 17, wherein the coat is formed by contacting the outer surface of the core with particulate solids comprising the base to form a base coated core, and contacting an outer surface of the base coated core with a solution comprising the urease inhibitor.

Aspect 20 is directed to a method of fertilizing, the method comprising applying a fertilizer granule of any one of aspects 1 to 16 to at least a portion of a soil, a crop, or the soil and the crop

### BRIEF DESCRIPTION OF THE DRAWINGS

Advantages of the present invention may become apparent to those skilled in the art with the benefit of the following detailed description and upon reference to the accompanying drawings. While the invention is susceptible to various modifications and alternative forms, specific embodiments thereof are shown by way of example in the drawings. The drawings may not be to scale.

FIG. 1A) A fertilizer granule according to one example of the present invention. FIG. 1B) A fertilizer granule according to another example of the present invention.

FIG. 2A) a flowchart of a method for producing a fertilizer granule according to one example of the present invention. FIG. 2B) a flowchart of a method for producing a fertilizer granule according to another example of the present invention.

### DETAILED DESCRIPTION OF THE INVENTION

The fertilizer granule of the present invention can contain a urease inhibitor and a base coating a core. The core can contain phosphoric acid and an urea adduct containing urea and calcium sulfate. As illustrated in a non-limiting manner in Example 1, it was found that adding a base to a fertilizer particle core containing UCS and phosphoric acid can reduce degradation of a urease inhibitor in a coating on the core.

These and other non-limiting aspects of the present invention are discussed in further detail in the following sections.

### A. Fertilizer Granules

The fertilizer granule can contain a core and a coat forming a coating on the core. The fertilizer granule can contain 90 wt. % to 99 wt. % of the core, e.g., the fertilizer granule is comprised of 90 wt. % to 99 wt. % or at least any one of, equal to any one of, or between any two of 90 wt. %, 91 wt. %, 92 wt. %, 93 wt. %, 94 wt. %, 95 wt. %, 96 wt. %, 97 wt. %, 98 wt. % and 99 wt. % of the core. The core can contain an urea adduct and phosphoric acid. The urea adduct can be a urea-calcium sulfate (UCS) adduct and can contain urea and calcium sulfate. The UCS adduct can be CaSO₄.4CO(NH₂)₂. In some aspects, the core can contain 40 wt. to 85 wt. % or at least any one of, equal to any one of, or between any two of 40 wt. %, 45 wt. %, 50 wt. %, 55 wt. %, 60 wt. %, 65 wt. %, 70 wt. %, 75 wt. %, 80 wt. %, and 85 wt. % of the UCS adduct. In certain aspects, the core can further contain free urea that is not contained in the UCS adduct and/or free calcium sulfate that is not contained in the UCS adduct. In some aspects, the core can contain i) 47 wt. % to 79.5 wt. %, or at least any one of, equal to any one of, or between any two of 47 wt. %, 50 wt. %, 55 wt. %, 60 wt. %, 65 wt. %, 70 wt. %, 75 wt. %, and 79.5 wt. %, of urea in total, present freely and/or within the UCS adduct, ii) 20 wt. % to 45 wt. %, or at least any one of, equal to any one of, or between any two of 20 wt. %, 25 wt. %, 30 wt. %, 35 wt. %, 40 wt. %, and 45 wt. % of CaSO₄ in total, present freely and/or within the UCS adduct and iii) 0.1 wt. % to 3 wt. %, or at least any one of, equal to any one of, or between any two of 0.1 wt. %, 0.2 wt. %, 0.3 wt. %, 0.4 wt. %, 0.5 wt. %, 0.6 wt. %, 0.7 wt. % 0.8 wt. %, 0.9 wt. %, 1 wt. %, 1.2 wt. %, 1.4 wt. %, 1.6 wt. %, 1.8 wt. %, 2 wt. %, 2.2 wt. %, 2.4 wt. %, 2.6 wt. %, 2.8 wt. %, 3 wt. % of phosphoric acid. based on the total weight of the core.

The UCS adduct in the core can be formed by an adduct forming reaction between calcium sulfate from phosphogypsum and urea. The calcium sulfate present freely and contained within the UCS adduct in the core can be obtained from phosphogypsum. The phosphoric acid in the core can be obtained from phosphogypsum. In some aspects, the phosphogypsum can be obtained from a phosphoric acid manufacturing process. In some aspects, the core does not contain or is substantially free of a binder, filler, pH buffer, urease inhibitor, and/or nitrification inhibitor.

The core can be of any suitable shape. Non-limiting shapes include spherical, cuboidal, cylindrical, puck shape, oval, and oblong shapes. In some aspects, the core can be of cylindrical shape with a circular, elliptical, ovular, triangular, square, rectangular, pentagonal, or hexagonal cross section, although cylindrical shaped core having a cross-section of other shapes can also be made. In some aspects, the core can have a dimension such as length, width, height and/or cross-sectional diameter between 0.5 mm to 5 mm or at least any one of, equal to any one of, or between any two of 0.5 mm, 1 mm, 1.5 mm, 2 mm, 2.5 mm, 3 mm, 3.5 mm, 4 mm, 4.5 mm, and 5 mm. In some particular aspects, the core can have a substantially spherical shape with an average diameter 1 mm to 5 mm or at least any one of, equal to any one of, or between any two of 0.5 mm, 1 mm, 1.5 mm, 2 mm, 2.5 mm, 3 mm, 3.5 mm, 4 mm, 4.5 mm, and 5 mm.

The fertilizer granule can contain 0.2 wt. % to 8 wt. % of the coat, e.g., 1 wt. % to 6 wt. % or at least any one of, equal to any one of, or between any two of 0.2 wt. %, 1 wt. %, 2 wt. %, 3 wt. %, 4 wt. %, 5 wt. %, 6 wt. %, 7 wt. % and 8 wt. % of the fertilizer granule can be comprised of the coat. The coat can contain an urease inhibitor and a base. The base can contain an oxide, carbonate, acetate and/or hydroxide of a group 1 metal, group 2 metal, group 13 metal, and/or ammonium. In certain aspects, the group 1 metal can be lithium (Li), sodium (Na), and/or potassium (K). In certain aspects, the group 2 metal can be beryllium (Be), magnesium (Mg), calcium (Ca), barium (Ba), and/or strontium (Sr). In certain aspects, the group 13 metal can be aluminum (Al), gallium (Ga), indium (In), or thallium (Tl). In certain aspects, the base can contain CaO and/or MgO. In some particular aspects, the base can be MgO. In certain aspects, the base such as MgO can be comprised in particulate solids. In some aspects, the micronized particles can have an average size, e.g., an average diameter, of 0.1 μm to 150 μm, or 1 μm to 50 μm, or at least any one of, equal to any one of, or between any two of 0.1 μm, 0.3 μm, 0.5 μm, 1 μm, 2 μm, 4 μm, 6 μm, 8 μm, 10 μm, 15 μm, 20 μm, 25 μm, 30 μm, 35 μm, 40 μm, 50 μm, 60 μm, 70 μm, 80 μm, 100 μm, 110 μm, 120 μm, 130 μm, 140 μm, and 150 μm. In some aspects, the fertilizer granule can contain 0.2 wt. % to 7 wt. % or at least any one of, equal to any one of, or between any two of 0.2 wt. %, 0.5 wt. %, 1 wt. %, 2 wt. %, 3 wt. %, 4 wt. %, 5 wt. %, 6 wt. %, 7 wt. % of the base, such as MgO. In certain aspects, the urease inhibitor can contain a thiophosphoric triamide derivative or phenyl phosphorodiamidate (PPDA). In certain aspects, the thiophosphoric triamide derivative can be N-(n-butyl) thiophosphoric triamide (NBPT). In some aspects, the fertilizer granule can comprise 0.01 wt. % to 0.2 wt. % or at least any one of, equal to any one of, or between any two of 0.01 wt. %, 0.05 wt. %, 0.1 wt. %, 0.15 wt. % and 0.2 wt. % of the urease inhibitor, such as NBPT. In some aspects, the fertilizer granule can contain NBPT and MgO at a weight ratio of 0.005:1 to 0.1:1 or at least any one of, equal to any one of, or between any two of 0.005:1, 0.01:1, 0.02:1, 0.03:1, 0.04:1, 0.05:1, 0.06:1, 0.07:1, 0.08:1, 0.09:1 and 0.1:1.

The coat can contain one or more coating layers. In some aspects, the urease inhibitor and the base can be contained in the same coating layer. In some aspects, the coat can contain at least two coating layers, a base containing alkaline coating layer and a urease inhibitor containing inhibitor coating layer. The alkaline coating layer and the inhibitor coating layer can form separate coating layers on the core. The coat overall can cover 5, 10, 15, 20, 25, 30, 35, 40, 45, 50, 55, 60, 65, 70, 75, 80, 85, 90, 95, 99, or 100% of the outer surface of the core. In certain aspects, the alkaline coating layer can further contain a micronutrient. A micronutrient is a botanically acceptable form of an inorganic or organometallic compound such as boron, copper, iron, chloride, manganese, molybdenum, nickel, or zinc. In certain aspects, the inhibitor coating layer can further contain a nitrification inhibitor. In some aspects, the nitrification inhibitor can be 3,4-dimethylpyrazole phosphate (DMPP), thio-urea (TU), dicyandiamide (DCD), 2-Chloro (trichloromethyl)-pyridine (Nitrapyrin), 5-Ethoxy-3-trichloromethyl-1, 2, 4-thiadiazol (Terrazole), 2-Amino-4-chloro-6-methyl-pyrimidine (AM), 2-Mercapto-benzothiazole (MBT), or 2-Sulfanimalamidothiazole (ST) or any combination thereof, preferably DCD. In some aspects, the fertilizer particle can include 0.1 wt. % to 5 wt. % of the nitrification inhibitor such as DCD.

In some aspects, the alkaline coating layer can form a coating over at least a portion of an outer surface of the core to form a base coated core and the inhibitor coating layer can form a coating over at least a portion of an outer surface of the base coated core to form the fertilizer granule. In some aspects, at least a portion of the alkaline coating layer can be positioned between the core and the inhibitor coating layer. In some aspects, the inhibitor coating layer can form an outer coating layer of the fertilizer granule. The alkaline coating layer can cover 5, 10, 15, 20, 25, 30, 35, 40, 45, 50, 55, 60, 65, 70, 75, 80, 85, 90, 95, 99, or 100% of the outer surface of the core. The inhibitor coating layer can cover 5, 10, 15, 20, 25, 30, 35, 40, 45, 50, 55, 60, 65, 70, 75, 80, 85, 90, 95, 99, or 100% of the outer surface of the base coated core.

In some other aspects, the inhibitor coating layer can form a coating over at least a portion of an outer surface of the core to form an inhibitor coated core and the alkaline coating layer can form a coating over at least a portion of an outer surface of the inhibitor coated core to form the fertilizer granule. In some aspects, at least a portion of the inhibitor coating layer can be positioned between the core and the alkaline coating layer. In some aspects, the alkaline coating layer can form an outer coating layer of the fertilizer granule. The inhibitor coating layer can cover 5, 10, 15, 20, 25, 30, 35, 40, 45, 50, 55, 60, 65, 70, 75, 80, 85, 90, 95, 99, or 100% of the outer surface of the core. The alkaline coating layer can cover 5, 10, 15, 20, 25, 30, 35, 40, 45, 50, 55, 60, 65, 70, 75, 80, 85, 90, 95, 99, or 100% of the outer surface of the inhibitor coated core.

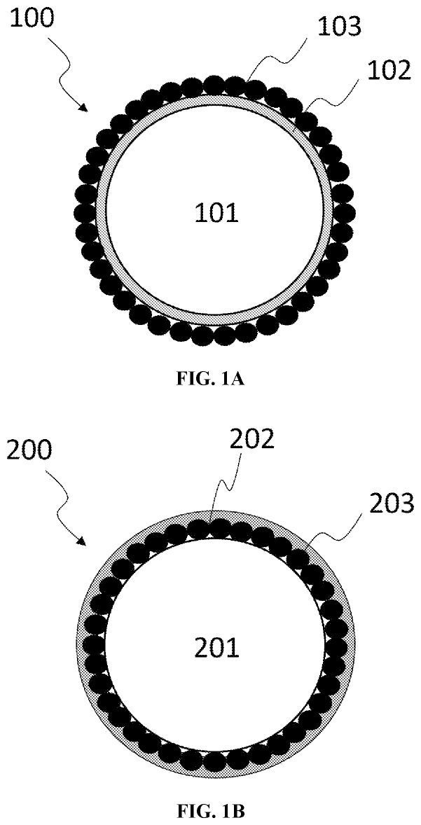

Referring to FIG. 1A a fertilizer granule 100 according to an example of the present invention is shown. The fertilizer granule 100 contains a core 101, urease inhibitor containing inhibitor coating layer 102 coating an outer surface of the core, and alkaline coating layer 103 containing micronized particles containing a base, such as MgO, coating an outer surface of the inhibitor coating layer coated core, e.g., inhibitor coated core. The inhibitor coating layer 102 is represented as covering the entire outer surface of the core 101, although fertilizer granules with the inhibitor coating layer 102 covering a portion of the outer surface of the core can readily be made. The alkaline coating layer 103 is represented as covering the entire outer surface of the inhibitor coating layer coated core, although fertilizer granules with alkaline coating layer 103 covering a portion of the outer surface of the inhibitor layer coated core can readily be made.

Referring to FIG. 1B a fertilizer granule 200 according to a second example of the present invention is shown. The fertilizer granule 200 contains a core 201, an alkaline coating layer 202 containing micronized particles containing a base, such as MgO, coating an outer surface of the core, and an urease inhibitor containing inhibitor coating layer 203 coating an outer surface of the alkaline coating layer coated core, e.g., base coated core. The alkaline coating layer 202 is represented as covering the entire outer surface of the core 201, although fertilizer granules with the alkaline coating layer 202 covering a portion of the outer surface of the core can readily be made. The inhibitor coating layer 203 is represented as covering the entire outer surface of the alkaline coating layer coated core, although fertilizer granules with inhibitor coating layer 203 covering a portion of the outer surface of the alkaline coating layer coated core can readily be made.

In some aspects, the fertilizer granule can contain a) a core containing i) 47 wt. % to 79.5 wt. %, or at least any one of, equal to any one of, or between any two of 47 wt. %, 50 wt. %, 55 wt. %, 60 wt. %, 65 wt. %, 70 wt. %, 75 wt. %, and 79.5 wt. %, of urea in total, present freely and/or within the UCS adduct, ii) 20 wt. % to 45 wt. %, or at least any one of, equal to any one of, or between any two of 20 wt. %, 25 wt. %, 30 wt. %, 35 wt. %, 40 wt. %, and 45 wt. % of CaSO₄ in total, present freely and/or within the UCS adduct and iii) 0.1 wt. % to 3 wt. %, or at least any one of, equal to any one of, or between any two of 0.1 wt. %, 0.2 wt. %, 0.3 wt. %, 0.4 wt. %, 0.5 wt. %, 0.6 wt. %, 0.7 wt. % 0.8 wt. %, 0.9 wt. %, 1 wt. %, 1.2 wt. %, 1.4 wt. %, 1.6 wt. %, 1.8 wt. %, 2 wt. %, 2.2 wt. %, 2.4 wt. %, 2.6 wt. %, 2.8 wt. %, 3 wt. % of phosphoric acid, wherein wt. % of i), ii) and iii) are based on the total weight of the core, and b) a coat containing iv) 0.5 wt. % to 5 wt. % or at least any one of, equal to any one of, or between any two of 0.5 wt. %, 1 wt. %, 2 wt. %, 3 wt. %, 4 wt. %, and 5 wt. % of MgO and v) 0.01 wt. % to 0.2 wt. % or at least any one of, equal to any one of, or between any two of 0.01 wt. %, 0.05 wt. %, 0.1 wt. %, 0.15 wt. % and 0.2 wt. % of NBPT, wherein wt. % of iv) and v) are based on the total weight of the fertilizer granule.

In some aspects, the core and/or coat contains a filler, binder, talc, pH buffer, and/or anticaking agent. In some aspects, the core and/or coat contains, based on total weight of the core and/or coat respectively, less than 0.5 wt. %, or less than 0.1 wt. %, or is substantially free, or is free of a filler such as each of silica, dried distillers grains with solubles (DDGS), bone mill powder, and rice husk. In some aspects, the core and/or coat contains based on total weight of the core and/or coat respectively less than 0.5 wt. %, or less than 0.1 wt. %, or is substantially free, or is free of a binder such as each of flour, bleached wheat flour, starch, gluten, kaolin, bentonite, and colloidal silica. In some aspects, the core and/or coat contains, based on total weight of the core and/or coat respectively, less than 0.5 wt. %, or less than 0.1 wt. %, or is substantially free, or is free of talc. In some aspects, the core and/or coat contains, based on total weight of the core and/or coat respectively, less than 0.5 wt. %, or less than 0.1 wt. %, or is substantially free, or is free of a pH buffer. In some aspects, the core and/or coat contains, based on total weight of the core and/or coat respectively, less than 0.5 wt. %, or less than 0.1 wt. %, or is substantially free, or is free of an anticaking agent.

In some aspects, additional fertilizer substances besides urea can be included or excluded in the core of the fertilizer granules. If included, additional fertilizers can be chosen based on the particular needs of certain types of soil, climate, or other growing conditions to maximize the efficacy of the fertilizer granule in enhancing plant growth and crop yield. Additional additives may also be included or excluded in the fertilizer granules. Non-limiting examples of additives that can be included or excluded from the fertilizer granules of the present invention include micronutrients, additional nitrogen nutrients, and/or secondary nutrients. A micronutrient is a botanically acceptable form of an inorganic or organometallic compound such as boron, copper, iron, chloride, manganese, molybdenum, nickel, or zinc. An additional nitrogen nutrient is a nutrient other than urea can deliver nitrogen to a plant. In some aspects, the additional nitrogen nutrient can include ammonium nitrate, ammonium sulfate, diammonium phosphate, monoammonium phosphate, urea-formaldehyde, ammonium chloride, and potassium nitrate. A secondary nutrient is a substance that can deliver calcium, magnesium, and/or sulfur to a plant. In some aspects, the secondary nutrients may include lime, gypsum, superphosphate, or a combination thereof.

The core of the fertilizer granules can have desirable physical properties such as desired levels of abrasion resistance, granule strength, pelletizability, hygroscopicity, granule shape, and size distribution, which are important properties for the fertilizer core.

The fertilizer granules described herein can be comprised in a composition useful for application to soil. In addition to the fertilizer granules, the composition may include other fertilizer compounds, micronutrients, primary nutrients, additional urea, additional nitrogen nutrients, insecticides, herbicides, or fungicides, or combinations thereof.

The fertilizer granules described herein can also be included in a blended composition comprising other fertilizer granules. The other fertilizer granules can be granules of urea, monoammonium phosphate (MAP), diammonium phosphate (DAP), muriate of potash (MOP), monopotassium phosphate (MKP), triple super phosphate (TSP), rock phosphate, single super phosphate (SSP), ammonium sulfate, and the like.

### B. Method of Making a Fertilizer Granule

One aspect of the present invention is directed to a method for making a fertilizer granule, such as a fertilizer granule disclosed herein. In certain aspects, the method can include forming or providing a core containing phosphoric acid and an urea adduct containing urea and calcium sulfate; and coating an outer surface of the core with an urease inhibitor, a base, and optionally a nitrification inhibitor and/or a micronutrient to form a coat. In some aspects, the coat can be formed by contacting the outer surface of the core with the urease inhibitor and optionally the nitrification inhibitor to form an inhibitor coated core, and contacting an outer surface of the inhibitor coated core with particulate solids containing the base and optionally a micronutrient. In some aspects, the coat can be formed by contacting the outer surface of the core with particulate solids containing the base and optionally a micronutrient to form a base coated core, and contacting an outer surface of the base coated core with an urease inhibitor and optionally a nitrification inhibitor. In some aspects, the coat can be formed by contacting the outer surface of the core with a combination of particulate solids containing the base and an urease inhibitor and optionally a micronutrient and/or a nitrification inhibitor. In certain aspects, a solution containing the urease inhibitor can be contacted with, such as sprayed on, the outer surface of the core or base coated core. In some aspects, the solution can be an aqueous solution containing 15 wt. % to 40 wt. % or at least any one of, equal to any one of, or between any two of 15 wt. %, 20 wt. %, 25 wt. %, 30 wt. %, 35 wt. %, and 40 wt. % of the urease inhibitor.

In some aspects, the core or based coated core can be coated with 0.3 kg to 3 kg or at least any one of, equal to any one of, or between any two of 0.3, 0.5, 1, 1.5, 2, 2.5, and 3 kg of the urease inhibitor such as NBPT per ton of urea e.g. present freely and in the UCS adduct, in the core. In some aspects, the core or inhibitor coated core can be coated with 2 kg to 30 kg or at least any one of, equal to any one of, or between any two of 2, 4, 6, 8, 10, 12, 14, 16, 18, 20, 22, 24, 26, 28, and 30 kg of the base such as MgO per ton of urea e.g. present freely and in the UCS adduct, in the core.

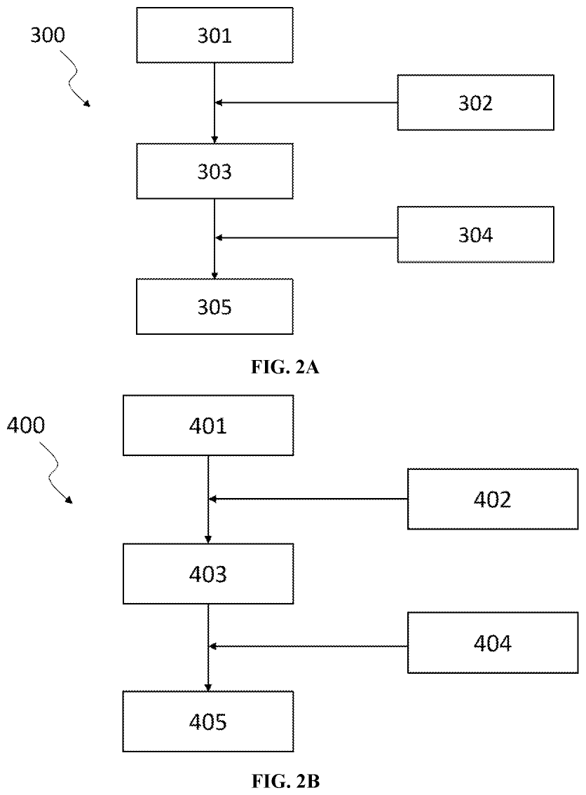

FIG. 2A shows a flow chart of a method 300 for making a fertilizer granule according to one example of the present invention. Referring to FIG. 2A, a core 301 can be coated with a solution containing an urease inhibitor 302 to form an inhibitor coated core 303, the inhibitor coated core 303 can be coated with micronized particles containing a base 304 to form a coated fertilizer granule 305. FIG. 2B shows a flow chart of a method 400 for making a fertilizer granule according to another example of the present invention. Referring to FIG. 2B, a core 401 can be coated with micronized particles containing a base 402 to form a base coated core 403, the base coated core 403 can be coated with a solution containing an urease inhibitor 404 to form a coated fertilizer granule 405.

In some particular aspects, a core in a form of prills and/or granules of size 1 mm to 5 mm can be provided in a container, such as a drum coater or a granulator. An aqueous solution containing 15 wt. % to 40 wt. % of an urease inhibitor such as NBPT can be sprayed on the core prills and/or granules in the container to form an inhibitor coated core, e.g., NBPT coated core. Micronized particles containing a base such as MgO can be added to the container to coat the NBPT coated core with the micronized particles to form the fertilizer granules.

In some other aspects, a core in a form of prills and/or granules of size 1 mm to 5 mm can be provided in a container, such as a drum coater or a granulator. Micronized particles containing a base such as MgO, can be added to the container to coat the core prills and/or granules in the container to form a base coated core, e.g., MgO coated core. An aqueous solution containing 15 wt. % to 40 wt. % of an urease inhibitor such as NBPT can be sprayed on the MgO coated core to form the fertilizer granules.

In certain aspects, the core can be formed by contacting urea with phosphogypsum to form a slurry containing a UCS adduct, drying the slurry to form a dried UCS adduct and granulating the dried UCS adduct. The UCS adduct can be formed by an adduct forming reaction between calcium sulfate present in the phosphogypsum and urea (equation 1).

CaSO₄·2H₂O+4CO(NH₂)₂→CaSO₄·4CO(NH₂)₂+2H₂O (1)

The urea and phosphogypsum can be contacted in presence of water to form the slurry. In certain aspects, urea in form of an urea solution, urea particles, urea granules, or urea prills, or any combination thereof can be contacted with the phosphogypsum to form the slurry. In some aspects, the urea solution contacted with the phosphogypsum can contain 10 wt. % to 40 wt. % or at least any one of, equal to any one of, or between any two of 10 wt. %, 15 wt. %, 20 wt. %, 25 wt. %, 30 wt. %, 35 wt. %, and 40 wt. %, of water. In some aspects, a phosphogypsum having 2 wt. % to 30 wt. % or at least any one of, equal to any one of, or between any two of 2 wt. %, 5 wt. %, 10 wt. %, 15 wt. %, 20 wt. %, 25 wt. % and 30 wt. % of moisture can be contacted with urea to form the slurry. In some aspects, the slurry can contain 10 wt. % to 40 wt. % or at least any one of, equal to any one of, or between any two of 10 wt. %, 15 wt. %, 20 wt. %, 25 wt. %, 30 wt. %, 35 wt. %, and 40 wt. %, of water. Urea can be contacted with phosphogypsum at molar ratio of 3:1 to 5:1 or at least any one of, equal to any one of, or between any two of 3:1, 3.5:1, 4:1, 4:5 and 5:1 of urea to calcium sulfate contained in the phosphogypsum. In some aspects, the urea and phosphogypsum can be contacted at 40° C. to 90° C., or at least any one of, equal to any one of, or between any two of 40° C., 45° C., 50° C., 55° C., 60° C., 65° C., 70° C., 75° C., 80° C., 85° C., and 90° C. In certain aspects, the slurry can be dried at 35° C., 40° C., 45° C., 50° C., 55° C., 60° C., 65° C., 70° C., 75° C., 80° C., 85° C., 90° C., 95° C., 100° C. or greater, or any temperature or range thereof or there between to form the dried UCS adduct. The amount of water, e.g., moisture, in the dried UCS adduct can be less than 0.6 wt. %, 0.5 wt. %, 0.4 wt. %, 0.3 wt. %, 0.2 wt. %, 0.1 wt. %, or less, or any amount or range thereof or there between. The amount of UCS adduct in the core can be 40 wt. %, over 40 wt. %, over 45 wt. %, over 50 wt. %, over 55 wt. %, over 60 wt. %, over 65 wt. %, over 70 wt. %, over 75 wt. %, over 80 wt. %, over 85 wt. %, or any amount or range thereof or there between. The dried UCS adduct can be granulated at 65° C. to 95° C., or at least any one of, equal to any one of, or between any two of 65, 70, 75, 80, 85, 90 and 95° C. The core can be formed from the dried UCS adduct and the core can be coated in the same or in a different granulator. In certain aspects, the granulator used for granulating the dried UCS adduct and/or coating the core can be a granulation drum, pugmill, pan granulator, etc.

### C. Methods of Using Fertilizer Granules

The fertilizer granule(s) and fertilizer blend containing the fertilizer granule(s) of the present invention can be used in methods of increasing the amount of nitrogen in soil and of enhancing plant growth. Such methods can include applying to the soil an effective amount of a composition comprising the fertilizer granule(s) of the present invention. The method may include increasing the growth and yield of crops, trees, ornamentals, etc., such as, for example, palm, coconut, rice, wheat, corn, barley, oats, and soybeans. The method can include applying the fertilizer blend of the present invention to at least one of a soil, an organism, a liquid carrier, a liquid solvent, etc.

Non-limiting examples of plants that can benefit from the fertilizer of the present invention include vines, trees, shrubs, stalked plants, ferns, etc. The plants may include orchard crops, vines, ornamental plants, food crops, timber, and harvested plants. The plants may include Gymnosperms, Angiosperms, and/or Pteridophytes. The Gymnosperms may include plants from the Araucariaceae, Cupressaceae, Pinaceae, Podocarpaceae, Sciadopitaceae, Taxaceae, Cycadaceae, and Ginkgoaceae families. The Angiosperms may include plants from the Aceraceae, Agavaceae, Anacardiaceae, Annonaceae, Apocynaceae, Aquifoliaceae, Araliaceae, Arecaceae, Asphodelaceae, Asteraceae, Berberidaceae, Betulaceae, Bignoniaceae, Bombacaceae, Boraginaceae, Burseraceae, Buxaceae, Canellaceae, Cannabaceae, Capparidaceae, Caprifoliaceae, Caricaceae, Casuarinaceae, Celastraceae, Cercidiphyllaceae, Chrysobalanaceae, Clusiaceae, Combretaceae, Cornaceae, Cyrillaceae, Davidsoniaceae, Ebenaceae, Elaeagnaceae, Ericaceae, Euphorbiaceae, Fabaceae, Fagaceae, Grossulariaceae, Hamamelidaceae, Hippocastanaceae, Illiciaceae, Juglandaceae, Lauraceae, Lecythidaceae, Lythraceae, Magnoliaceae, Malpighiaceae, Malvaceae, Melastomataceae, Meliaceae, Moraceae, Moringaceae, Muntingiaceae, Myoporaceae, Myricaceae, Myrsinaceae, Myrtaceae, Nothofagaceae, Nyctaginaceae, Nyssaceae, Olacaceae, Oleaceae, Oxalidaceae, Pandanaceae, Papaveraceae, Phyllanthaceae, Pittosporaceae, Platanaceae, Poaceae, Polygonaceae, Proteaceae, Punicaceae, Rhamnaceae, Rhizophoraceae, Rosaceae, Rubiaceae, Rutaceae, Salicaceae, Sapindaceae, Sapotaceae, Simaroubaceae, Solanaceae, Staphyleaceae, Sterculiaceae, Strelitziaceae, Styracaceae, Surianaceae, Symplocaceae, Tamaricaceae, Theaceae, Theophrastaceae, Thymelaeaceae, Tiliaceae, Ulmaceae, Verbenaceae, and/or Vitaceae family.

The effectiveness of compositions comprising the fertilizer granule(s) of the present invention can be ascertained by measuring the amount of nitrogen in the soil at various times after applying the fertilizer composition to the soil. It is understood that different soils have different characteristics, which can affect the stability of the nitrogen in the soil. The effectiveness of a fertilizer composition can also be directly compared to other fertilizer compositions by doing a side-by-side comparison in the same soil under the same conditions.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Urease Inhibitor and Magnesium Oxide Coated Urea Calcium Sulfate (UCS)

Methods: Coated UCS containing fertilizer granules were prepared using a drum coating system with a batch process. The lab scale drum coating system had a capacity of 200 grams to 2 kilograms and had a drum interchanging facility based on the required volume. The drum contained four baffles 0.5 inch in height and 1 inch in width across the drum length. The drum coater system was worked in manual mode starting from feeding, pumping, spraying, exhausting, drying, and discharging the coated material. The urease inhibitor and the magnesium oxide used to coat the UCS granules were obtained from commercial sources. The UCS granules were made from urea and phosphogypsum. The UCS granules contained 0.2-1.2 wt. % of phosphoric acid.

Three parallel experiments were performed. In experiment 1, 199.54 g of granular UCS product was weighed and fed into the drum. 0.46 g of a solution containing 26 wt. % of urease inhibitor was pumped into the drum using a peristatic pump. The pump was connected to a spray nozzle with orifice design. The solution was atomized by compressed air and was sprayed onto the granular UCS adduct. An exhaust pipe line on top of the drum took off the compressed air. After completion of spraying the coating solution, the drum was rotated continually for five more minutes to ensure dispersion of the coating. Then rotation of the drum was stopped and the inhibitor coated UCS product was collected for packing.

In experiment 2, 195.54 g of granular UCS product was weighed and fed into the drum. 4 g magnesium oxide as a powder was added to the drum. Then 0.46 g of a solution containing 26 wt. % of urease inhibitor was pumped into the drum using a peristatic pump. The pump was connected to a spray nozzle with orifice design. The solution was atomized by compressed air and was sprayed on to the magnesium oxide coated granular UCS adduct. An exhaust pipe line on top of the drum took off the compressed air. After completion of spraying the coating solution, the drum was rotated continuously for five more minutes to ensure dispersion of the coating. Then rotation of the drum was stopped and the UCS coated first with 2% MgO and second with inhibitor product was collected for packing.

In experiment 3, 195.54 g of granular UCS product was weighed and fed into the drum. 0.46 g of a solution containing 26 wt. % of urease inhibitor was pumped into the drum using a peristatic pump. The pump was connected to a spray nozzle with orifice design. The solution was atomized by compressed air and was sprayed on to the granular UCS adduct. An exhaust pipe line on top of the drum took off the compressed air. After completion of spraying the coating solution, 4 g magnesium oxide as a powder was added to the drum, and the drum was rotated continuously for five more minutes to ensure dispersion of the coating. Then rotation of the drum was stopped and the UCS coated first with inhibitor and second with 2% MgO product was collected for packing.

Table 1 shows the process parameters for experiments 1, 2 and 3.

TABLE 1
process parameters for experiments 1, 2 and 3.

| Parameters | | |
|---|---|---|
| Drum RPM | 20 | |
| Urease inhibitor solution spray rate | 2 | ml/min |
| Spray nozzle type | orifice | |
| Spray nozzle distance from the coating bed | 300 to 600 | mm |
| Atomizing air pressure | 0.1 | bar |

Results: The coated UCS granules from experiments 1, 2, and 3 were stored and the urease inhibitor (NBPT) stability was monitored at room condition. The recovery of NBPT, e.g. concentration of NBPT remaining, after certain time intervals were quantified using an HPLC technique. Results shown in Table 2 demonstrate better stability of NBPT in the MgO coated UCS samples (experiment 2 and 3) compared to a granule without a MgO coating(experiment 1).

TABLE 2
Percentage NBPT recovery in blended
samples stored at room condition.

| | | Concentration of NBPT remaining in storage | | | | | |
|---|---|---|---|---|---|---|---|
| Experi- | | Day | Day | Day | Day | Day | Day |
| ment | Sample | 3 | 15 | 45 | 75 | 120 | 180 |
| 1 | UCS coated | 66% | 2% | 0% | 0% | 0% | 0% |
| | with inhibitor | | | | | | |
| | liquid | | | | | | |
| 2 | UCS coated | 100% | 100% | 100% | 92% | 80% | 74% |
| | first with 2 | | | | | | |
| | wt. % MgO | | | | | | |
| | followed by | | | | | | |
| | inhibitor liquid | | | | | | |
| | coating | | | | | | |
| 3 | UCS coated | 100% | 100% | 100% | 95% | 72% | 65% |
| | with inhibitor | | | | | | |
| | liquid followed | | | | | | |
| | by powder | | | | | | |
| | coating of 2 | | | | | | |
| | wt. % MgO | | | | | | |

1. A fertilizer granule comprising:
a core comprising phosphoric acid and an urea adduct comprising urea and calcium sulfate; and
a coat comprising an urease inhibitor and a base, the coat forming a coating on an outer surface of the core.

2. The fertilizer granule of claim 1, wherein the base is an oxide, carbonate, bicarbonate, acetate, and/or hydroxide of a group 1 metal, group 2 metal, group 13 metal, and/or ammonium.

3. The fertilizer granule of claim 1, wherein the base is CaO and/or MgO.

4. The fertilizer granule of claim 1, wherein the urease inhibitor is a thiophosphoric triamide derivative.

5. The fertilizer granule of claim 1, wherein the coat comprises an alkaline coating layer comprising the base and an inhibitor coating layer comprising the urease inhibitor, wherein the alkaline coating layer and the inhibitor coating layer form separate coating layers.

6. The fertilizer granule of claim 5, wherein at least a portion of the alkaline coating layer is arranged between the core and the inhibitor coating layer.

7. The fertilizer granule of claim 5, wherein at least a portion of the inhibitor coating layer is arranged between the core and the alkaline coating layer.

8. The fertilizer granule of claim 1, wherein the base is comprised in particulate solids.

9. The fertilizer granule of claim 8, wherein the particulate solids have an average diameter of 0.1 μm to 150 μm.

10. The fertilizer granule of claim 1, wherein the core comprises: 47 wt. % to 79.5 wt. % of urea; 20 wt. % to 45 wt. % of calcium sulfate; and 0.1 wt. % to 3 wt. % of phosphoric acid, based on the total weight of the core.

11. The fertilizer granule of claim 1, wherein 90 wt. % to 99 wt. % of the fertilizer granule is comprised of the core.

12. The fertilizer granule of claim 1, wherein the fertilizer granule comprises 0.2 wt. % to 7 wt. % of the base.

13. The fertilizer granule of claim 1, wherein the fertilizer granule comprises 0.01 wt. % to 0.2 wt. % of the urease inhibitor.

14. The fertilizer granule of claim 1, wherein at least a portion of the calcium sulfate in the core is obtained from phosphogypsum.

15. The fertilizer granule of claim 14, wherein the phosphogypsum is obtained from a phosphoric acid manufacturing process.

16. The fertilizer granule of claim 1, comprised in a fertilizer blend or a compounded fertilizer.

17. A method for making the fertilizer granule of claim 1, the method comprising:
forming or providing a core comprising phosphoric acid and an urea adduct comprising urea and calcium sulfate; and
coating an outer surface of the core with a urease inhibitor and a base to form a coat.

18. The method of claim 17, wherein the coat is formed by contacting the outer surface of the core with a solution comprising the urease inhibitor to form an inhibitor coated core, and contacting an outer surface of the inhibitor coated core with particulate solids comprising the base.

19. The method of claim 17, wherein the coat is formed by contacting the outer surface of the core with particulate solids comprising the base to form a base coated core, and contacting an outer surface of the base coated core with a solution comprising the urease inhibitor.

20. A method of fertilizing, the method comprising applying a fertilizer granule of claim 1 to at least a portion of a soil, a crop, or the soil and the crop.
